(19) United States
(12) Patent Application Publication
(10) Pub. No.: US 2019/0389745 A1
(43) Pub. Date: Dec. 26, 2019

(54) DEVICE FOR IRRADIATING A FLOWING MEDIUM WITH UV RADIATION

(71) Applicant: ETA PLUS ELECTRONIC GMBH, Nürtingen (DE)

(72) Inventors: Peter Schwarz-Kiene, Kirchheim unter Teck (DE); Markus Roth, Nürtingen (DE); Simon Grosse-Kreul, Nürtingen (DE); Stefan Lechler, Wendlingen (DE)

(21) Appl. No.: 16/557,795

(22) Filed: Aug. 30, 2019

Related U.S. Application Data
(63) Continuation of application No. PCT/EP2018/054924, filed on Feb. 28, 2018.

(30) Foreign Application Priority Data
Mar. 1, 2017 (DE) 10 2017 104 273.3

(51) Int. Cl. C02F 1/32

(52) U.S. Cl. CPC C02F 1/325; C02F 2201/3223; C02F 2303/04; C02F 2201/326; C02F 2201/3228

(57) ABSTRACT

This disclosure relates to a device for irradiating a flowing medium with UV radiation, comprising a flow path for the medium and a gas discharge lamp which has a lamp vessel, arranged coaxially with respect to the flow path and enclosing a plasma chamber for a lamp plasma that emits UV radiation, and an excitation coil for electrodeless inductive excitation of radiation of the lamp plasma. According to a first aspect of this disclosure, a flow conduit body is arranged in the flow path, said flow conduit body being designed to influence, by virtue of its shape and/or its position, the flow of the medium for an even radiation absorption.

### RELATED APPLICATIONS

This application is a continuation of PCT/EP2018/054924, filed Feb. 28, 2018, which claims priority to DE 10 2017 104 273.3, filed Mar. 1, 2017, the entire disclosures of each of which are hereby incorporated herein by reference.

### BACKGROUND

This disclosure relates to a device for irradiating a flowing medium with UV radiation, in particular for water disinfection, comprising a flow path for the medium, which is preferably laterally delimited by a cladding tube, and a gas discharge lamp which has a preferably annular lamp vessel, arranged coaxially with respect to the flow path and enclosing a plasma chamber for a lamp plasma that emits UV radiation, and an excitation coil for electrodeless inductive excitation of radiation of the lamp plasma.

DE 10 2015 218 053.0 discloses a UV radiation device for water disinfection. In this document, a dual-end gas discharge lamp having terminal electrodes is provided in a conducting tube, for subjecting the medium flowing on the outer side to UV radiation.

UV medium pressure lamps usually have a UVC yield between about 10% and 15%, at high power densities (electric power) of about 20 to 60 W/cm³ plasma volume, while UV low pressure lamps have a high UVC yield of about 30% to 45%, however with considerably lower power densities of less than 0.5 W/cm³.

### SUMMARY

This disclosure teaches a UV irradiation reactor for flowing media, which operates with high efficiency and which satisfies special requirements, in particular with regard to the flow geometry and the lamp excitation, by using an electrodeless lamp type.

Accordingly, according to a first aspect of this disclosure, it is proposed that a flow conduit body is arranged in the flow path, wherein the flow conduit body is adapted by virtue of its shape and/or position, to influence the flow of the medium for an even radiation absorption. This makes it possible to ensure that each volume element of the flowing medium passing through the lamp receives a substantially uniform radiation dose.

In this context, it is of particular advantage if the flow conduit body is arranged axially in an annular chamber of the flow path irradiated by the gas discharge lamp, and if the flow conduit body has an in particular spherical head piece, on which the medium frontally flows.

An added benefit for a detection and, if necessary, adjustment of the irradiation can be achieved by arranging a UV sensor for detecting an irradiation intensity of the radiation emitted by the gas discharge lamp in a region of the flow conduit body that is permeable to UV radiation.

The use of such a sensor can be further simplified in that the flow conduit body has an end portion guided into the region of a connection flange for the flow path, and in that the UV sensor is insertable and removable via the end portion.

A further aspect of this disclosure provides that the lamp vessel comprises a lamp extension communicating with the plasma chamber for adjusting the vapor pressure of a component of the lamp plasma, wherein a temperature control device (temperature controller) is coupled to the lamp extension for temperature adjustment. This also allows the radiation efficiency of the plasma discharge to be further optimized.

In a particularly simple embodiment, which remains largely unaffected by the alternating magnetic field for lamp excitation, the temperature control device has an air duct configured for the controlled supply of cooling or heating air to the lamp extension.

Alternatively or additionally, it is also conceivable that the temperature control device has a Peltier element and/or electrical heating element, which are thermally coupled to the lamp extension.

In this case, a self-sufficient solution can be realized, in that the tempering is supplied with electrical energy through a decoupling coil, wherein the decoupling coil absorbs the energy from the electromagnetic alternating field generated by the excitation coil.

A further aspect of this disclosure provides that at least one radiation reflector for reflecting UV radiation into the medium is arranged on the flow path upstream and/or downstream of the gas discharge lamp. As a result, radiation components emerging laterally from the lamp can be reflected several times, which leads to an increase in reactor efficiency, in particular in the case of very transparent media.

In this connection, it can also be advantageous if the radiation reflector, preferably embodied as a cylindrical cladding tube mirror, has a conductive portion, preferably containing aluminum and a non-conductive portion, preferably made of PTFE, wherein the non-conductive portion is positioned near the gas discharge lamp and the conductive portion is arranged further away from the gas discharge lamp.

According to a further aspect of this disclosure, it is proposed that the lamp vessel and the excitation coil are enclosed in a shielding housing designed to shield alternating electromagnetic fields, so that permissible EMC limit values can be maintained outside thereof.

In order to ensure additional protection in the event of a leakage or line break, it is advantageous if the shielding housing is tightly connected to a fitting for the passage of the medium.

A high irradiation efficiency can also advantageously be achieved in that the medium flows through and around the radially inner side and outer side of the annular gas discharge lamp.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 shows a flow reactor for water disinfection comprising an electrodeless gas discharge lamp and a flow conduit body in a flow path in axial section;

FIG. 2 shows a circuit for a temperature control device on a lamp extension of a lamp vessel of the gas discharge lamp;

FIGS. 3 and 4 show further embodiments with a plurality of radiation reflectors and a plurality of gas discharge lamps in an axial section; and

FIG. 5 shows a further embodiment with a modified flow path for the water to be irradiated.

### DESCRIPTION

The embodiments described below are not intended to be exhaustive or to limit the invention to the precise forms disclosed in the following detailed description. Rather, the embodiments are chosen and described so that others skilled in the art may appreciate and understand the principles and practices of this disclosure.

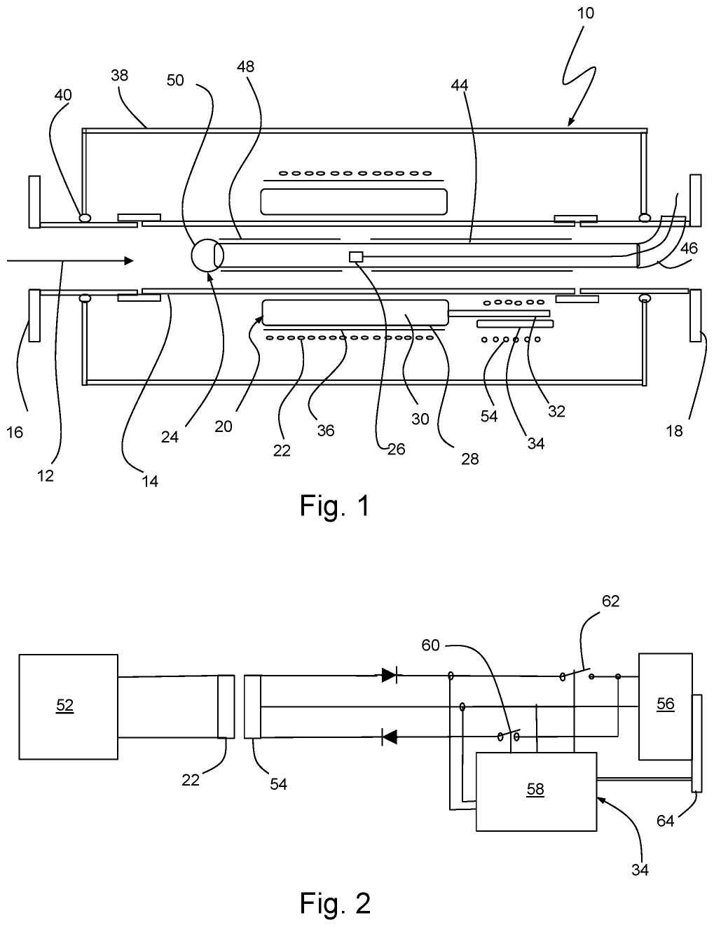

The flow reactor 10 shown in FIG. 1 is used for radiation treatment of a medium guided in a flow path 12 and in particular for water disinfection by means of UV radiation. In this case, the water to be treated flows through a cylindrical cladding or guide tube 14, which is provided on the inlet and outlet side with connection flanges 16, 18 for installation in a water pipe. An annular cylindrical gas discharge lamp 20 is arranged coaxially with the guide tube 14 and inductively excited by an external excitation coil 22 for generating radiation. In the guide tube 14 a flow conduit body 24 is arranged, which also houses a UV sensor 26 which detects radiation emitted by the gas discharge lamp 20.

The gas discharge lamp 20 comprises an annular lamp vessel 28 made of quartz glass, which encloses a plasma chamber 30 for a low-pressure plasma formed from mercury and noble gas. The lamp vessel 28 communicates with a lamp extension 32 for adjusting the mercury vapor pressure, wherein a temperature control device 34 is coupled to the lamp extension 32 for temperature adjustment.

To increase the efficiency, a lamp mirror 36 can be introduced between the excitation coil 22 and the lamp vessel 28, which mirror reflects back the useful radiation into the plasma chamber 30 and is permeable to the alternating fields of the excitation coil 22. The lamp mirror 36 can be provided by applying a mirror layer to the lamp vessel 28.

The gas discharge lamp 20 can be operated with a very high electrical power of up to about 1 kW per 0.1 m of lamp length (measured in the flow direction). The plasma chamber 30 can have a radial extent of up to approximately 5 cm, while the guide tube 14 has a diameter of, for example, 30 cm. For special applications, miniaturized reactors 10 are also conceivable, for example with a total power of 100 W and a guide tube diameter of 1 cm. The separation of the medium or fluid to be irradiated (liquid and/or gas) by means of the guide tube 14 allows the thermal decoupling of the lamp vessel 28 and thus the achievement of the optimum operating point (for example, about 30 to 60° C. depending on the filling). It is also conceivable to cool the lamp 20 by means of the fluid itself and possibly also by additional active or passive cooling on the side of the lamp remote from the guide tube 14. In operation, a gas discharge occurs in the plasma chamber 30 with the emission of UV radiation, in particular UVC radiation at 253.7 nm, which is particularly efficient for the sterilization of liquids or fluids.

In order to reduce the fields radiated by the excitation coil 22 outside the reactor arrangement, a shielding housing 38 is provided. In the simplest case, depending on the operating frequency, this can consist of highly conductive metals such as aluminum or copper. If insufficiently conductive metals (cast iron, etc.) are used, it is possible to line or coat them with conductive layers on the inside of the housing. The shielding housing should be designed so that also a leakage of substances is prevented in case of a possible breakage of the guide tube 14 or lamp vessel 28. It must therefore be designed accordingly for the operating pressure and reliably seal with respect to the flanges 16, 18 by means of seals 40.

The UV sensor 26 allows the detection of the UV radiation intensity in a relevant spectral range for evaluating the radiation power output from the gas discharge lamp 20 directly into the flowing medium. This can be done by considering the transparency of the medium as well as the permeability of the guide tube 14 and possibly a depositing of soil on the guide tube.

The UV sensor 26 is expediently arranged in a fluid-tight holding portion 44 of the flow conduit body 24. In this case, the flow conduit body 24 may have an end portion 46, which is guided into the region of the connecting flange 18, via which the UV sensor 26 is inserted and removed.

In order to increase the irradiation efficiency, especially in the case of very transparent fluids, by backscattering, the holding section 44 is cladded by a UV mirror layer 48, which is interrupted or transparent to the UV radiation in the region of the sensor 26.

The flow conduit body 24 makes it possible to influence the flow of the fluid in such a favorable manner, that the flow velocity distribution allows a high reactor efficiency. This can be achieved by adjusting the flow rate at any location in accordance with the irradiation intensity, so that the fluid volume element flowing through the reactor 10 absorbs the same dose of radiation and this dose achieves a maximum value based on the lamp power used. This can also be achieved in that a strong turbulence through the flow conduit body 24 ensures a high mixing of the fluid.

As shown, the flow conduit body 24 can be arranged axially in the center of the flow and can be so large in diameter that the effective area through which fluid flows becomes smaller than the optical path length in a strongly absorbing fluid. For this purpose, the flow conduit body 24 is advantageously provided with an in particular spherical head piece 50 on which the medium flows frontally.

As shown in the block diagram of FIG. 2, the excitation of the induction or excitation coil 22 of the gas discharge lamp 20 occurs via an electronic ballast 52. This works with sinusoidal frequencies of approx. 500 kHz to 5 MHz, ideally approx. 2 MHz. A too low frequency leads to high induction currents and thus lower efficiency of the overall arrangement, while a higher frequency leads to lower efficiency of the high-frequency generating ballast 52.

FIG. 2 also shows an expedient embodiment of the temperature control device 34 for the lamp extension 32, which extracts the energy required for cooling and regulation from the magnetic field of the excitation coil 22 through its own secondary decoupling coil 54. This self-sufficient solution has the advantage that no external wiring is necessary.

The cooling and heating of a region in the appendix or lamp extension 32 is performed by means of a Peltier element 56 and an associated control unit 58 for electronic adjustment and temperature measurement. For heating, the switch 60 is closed, and for cooling, switch 62 is closed. For the regulation, a temperature sensor 64 is provided. Additional shielding may be implemented around the lamp extension 32, possibly preventing inadvertent heating of the mercury or amalgam induced by the magnetic alternating field in the cold chamber delimited by the lamp extension 32 (not shown). Typical optimal cold chamber temperatures are, depending on filling, approx. 35° C. (pure mercury-inert gas discharge) up to about 100° C. (Hg bound in amalgam).

A cooling/heating of the lamp extension 32 by means of tempered air flow is also possible in a simple manner since air and suitable air guide elements do not interact with the magnetic alternating field.

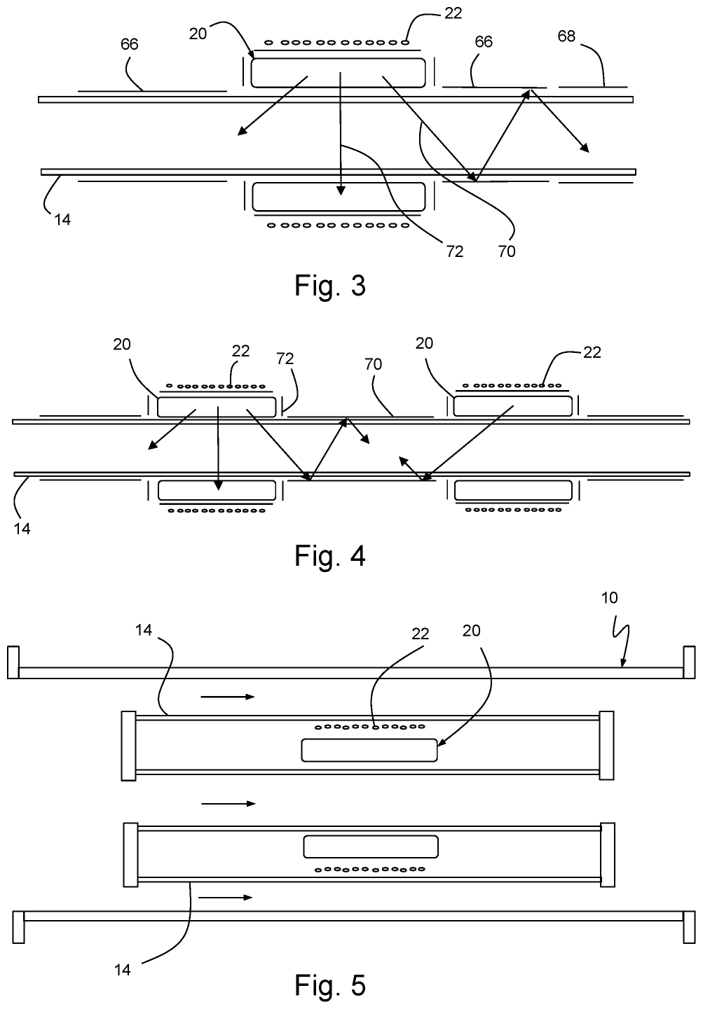

As illustrated in FIG. 3, reflectors 66, 68 on the outside of the guide tube 14, especially in the case of very transparent fluids, in which the optical path is significantly longer than the guide tube diameter, can lead to an increase in the reactor efficiency, because radiation components 70 exiting the lamp 20 laterally can be reflected several times. The lamp 22 radiates, in a first approximation, isotopically in all directions, and only the beam 72 exiting substantially perpendicular to the flow direction is reabsorbed in the opposite plasma layer.

The reflectors 66 which are positioned near the lamp should be made of electrically non-conductive materials (e.g., PTFE), and should not be absorbing (field weakening) for the working frequency of the alternating field. Otherwise, the magnetic field is changed unfavorably, which leads to a significant reduction in the overall efficiency of the arrangement.

Optionally, at some distance from the lamp (approx. corresponding to the lamp outside diameter), the reflector 68 may also be electrically conductive, in which case a high conductivity should ensure that the resulting eddy currents do not lead to high electrical losses. The advantage can be that even cheap aluminum mirrors can be used here. Furthermore, an electrically conductive reflector 68 shields the fields in the direction of the flanges 16, 18.

As illustrated in FIG. 4, in the case of very transparent fluids (air, ultrapure water), it may be advantageous to line up a plurality of shorter and thus less powerful individual lamps 22 and to provide the intermediate spaces with a guide tube mirror 70, respectively. As a result, the optical efficiency of the reactor 10 can be increased and thus the required lamp power can be reduced. The distance between the individual lamps 22 is typically greater than the lamp length. Optionally, the end faces of the lamp vessels 28 can be provided with non-conductive mirrors 72 (e.g., made of PTFE) for increasing the efficiency.

In the embodiment of a flow reactor 10 shown in FIG. 5, the medium or fluid to be irradiated flows both on the outside and on the inside of the gas discharge lamp 20. In the case of liquids, the lamp 20 is expediently arranged in an annular guide tube 14, while this is generally not necessary with gases. The induction coil 22 should be optimized in this configuration for the highest possible optical transmission, i.e., it should have large spaces between the individual turns and narrow conductors. Since the radiation outcoupling takes place towards the outside and the inside and the direct utilization of the radiation is more efficient than the reflection at a reflector, a significantly higher efficiency of the overall system can be achieved compared to a purely central flow.

While exemplary embodiments have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this invention pertains and which fall within the limits of the appended claims.

What is claimed is:

1. A device for irradiating a flowing medium with UV radiation for disinfection, the device comprising:
a cladding tube that delimits a flow path for the medium;
a gas discharge lamp arranged coaxially with respect to the flow path and enclosing a plasma chamber for a lamp plasma that emits UV radiation;
an excitation coil configured for electrodeless inductive excitation of radiation of the lamp plasma; and
a flow conduit body disposed in the flow path and configured to influence, by virtue of its shape and/or its position, the flow of the medium for even radiation absorption.

2. The device according to claim 1, wherein the flow conduit body is arranged axially in an annular chamber of the flow path, the chamber being configured to be irradiated by the gas discharge lamp.

3. The device according to claim 1, wherein the flow conduit body has a mirror layer configured to reflect the UV radiation.

4. The device according to claim 1, wherein the flow conduit body has a spherical head piece over which the medium flows frontally and has a cylindrical holding portion adjoining the head piece.

5. The device according to claim 1, comprising a UV sensor configured for detecting an irradiation intensity of the radiation emitted by the gas discharge lamp arranged in a region of the flow conduit body that is permeable to UV radiation.

6. The device according to claim 5, wherein the flow conduit body has an end portion which is guided in the region of a connecting flange for the flow path and the UV sensor is insertable and removable via the end portion.

7. The device according to claim 1, wherein the gas discharge lamp has a UV-reflecting lamp mirror on at least one side not facing the flow path.

8. A device for irradiating a flowing medium with UV radiation for disinfection, the device comprising:
a cladding tube that delimits a flow path for the medium;
a gas discharge lamp arranged coaxially with respect to the flow path and enclosing a plasma chamber for a lamp plasma that emits UV radiation;
an excitation coil configured for electrodeless inductive excitation of radiation of the lamp plasma;
a lamp extension communicating with the plasma chamber and configured for adjusting the vapor pressure of a component of the lamp plasma; and
a temperature controller coupled to the lamp extension and configured for temperature adjustment.

9. The device according to claim 8, wherein the temperature controller has an air duct configured for the controlled supply of cooling or heating air to the lamp extension.

10. The device according to claim 8, wherein the temperature controller has a Peltier element and/or an electrical heating element thermally coupled to the lamp extension.

11. The device according to claim 8, wherein the temperature controller is supplied with electrical energy through a decoupling coil, wherein the decoupling coil absorbs the energy from the electromagnetic alternating field generated by the excitation coil.

12. The device according to claim 8, wherein the lamp extension has a shield against the electromagnetic field generated by the excitation coil.

13. A device for irradiating a flowing medium with UV radiation for disinfection, the device comprising:
a cladding tube that delimits a flow path for the medium;
a gas discharge lamp arranged coaxially with respect to the flow path and enclosing a plasma chamber for a lamp plasma that emits UV radiation;
an excitation coil configured for electrodeless inductive excitation of radiation of the lamp plasma; and
at least one radiation reflector configured for reflection of UV radiation into the medium arranged on the flow path upstream and/or downstream of the gas discharge lamp.

14. The device according to claim 13, wherein the radiation reflector has a conductive portion and a non-conductive portion, wherein the non-conductive portion is positioned near the gas discharge lamp and the conductive portion is arranged further away from the gas discharge lamp than the non-conductive portion.

15. The device according to claim 14, wherein the conductive portion contains aluminum and the non-conductive portion is made of PTFE.

16. The device according to claim 13, wherein the gas discharge lamp comprises a plurality of gas discharge lamps and the radiation reflectors comprise a plurality of radiation reflectors, wherein the gas discharge lamps and radiation reflectors are arranged alternately along the flow path.

17. A device for irradiating a flowing medium with UV radiation for disinfection, the device comprising:
a cladding tube that delimits a flow path for the medium;
a gas discharge lamp arranged coaxially with respect to the flow path and enclosing a plasma chamber for a lamp plasma that emits UV radiation;
an excitation coil configured for electrodeless inductive excitation of radiation of the lamp plasma; and
a shielding housing that encloses the lamp vessel and the excitation coil, the shielding housing configured for shielding alternating electromagnetic fields.

18. The device according to claim 17, wherein the shielding housing is tightly connected to a fitting for the passage of the medium.

19. The device according to claim 17, wherein the shielding housing is formed of conducting metal or is provided on its inner side facing the gas discharge lamp with a conductive lining or coating.

20. The device according to claim 17, wherein the gas discharge lamp has a UV-reflecting lamp mirror on at least one side not facing the flow path.

21. The device according to claim 17, wherein the flow path is separated from the lamp vessel by the cladding tube, whereby the lamp vessel does not contact the flowing medium.
